(19) United States
(12) Patent Application Publication
(10) Pub. No.: US 2025/0245540 A1
(43) Pub. Date: Jul. 31, 2025

(54) SYSTEMS AND METHODS FOR IMPOSING QUANTUM CONTROL ON A QUANTUM COMPUTER USING GENERATED ELECTROMAGNETIC PULSES

(71) Applicant: HSBC Group Management Services Limited, London (GB)

(72) Inventors: Georgios KORPAS, Singapore (SG); Jakub MARECEK, Cernosice (CZ); Philip INTALLURA, London (GB); Ales WODECKI, London (GB)

(21) Appl. No.: 19/078,887

(22) Filed: Mar. 13, 2025

(30) Foreign Application Priority Data
Mar. 13, 2024 (GB) 2403652.7

(51) Int. Cl. G06N 10/40; G06N 10/60

(52) U.S. Cl. CPC G06N 10/40; G06N 10/60

(57) ABSTRACT

A heterogenous computing platform approach is proposed herein where a classical computer is configured to control a physical quantum pulse generation circuit to precisely manipulate quantum states of a quantum computer system using controlled magnetic pulses, driving the quantum computer system into a target state using a frequency-domain based harmonic-analytic approach.

### CROSS-REFERENCE TO RELATED APPLICATIONS

This application claims benefit of and priority to United Kingdom Application No. 2403652.7, filed Mar. 13, 2024, entitled “Quantum State Preparation”, the contents of which is incorporated into the present application by reference in its entirety.

### FIELD

The present claimed embodiments are directed to quantum computer processing and quantum computer architecture. Systems and methods for imposing quantum states on a quantum computer through precise manipulation of quantum states using controlled magnetic pulses are proposed.

### BACKGROUND

Quantum optimal control has important applications including initial state preparation in quantum computing, the implementation of gates in quantum computing, or laser control of chemical reaction. These are all of considerable and growing importance.

In quantum computing, quantum algorithms promise substantial speed-up in a variety of different applications such as quantum alternatives to Monte Carlo simulations or quantum optimisation. However, to attain these speedups, the initial quantum state preparation (or distribution needs to be performed accurately and within a reasonable amount of time. This is a significant technical problem. The speed-up is significant and an important source of technical “quantum advantage” that allows performance improvements relating to quantum computing that are not otherwise available.

When the complexity of initial quantum state preparation utilising one controlled rotation per scalar, also known as the Grover-Rudolph state preparation, is considered, any speed-up may vanish. As described herein, this complexity essentially reduces or eliminates the “quantum advantage” associated with quantum computing.

A prime example includes quantum algorithms replacing classical Monte Carlo simulations, where the Grover-Rudolph state preparation is known to remove the quantum-speed up even in the case of log-concave probability distributions. In general, loading an arbitrary quantum state over n qubit registers requires O(2ⁿ) CNOT gates which reduces any potential for a useful speed up. It is hence natural to seek alternative methods for initial quantum state preparation. While several approaches have been suggested in the literature, approaches such as Quantum Generative Adversarial Network- (qGAN-) based and often suffer from the typical technical problems of parameterised quantum circuits.

Diving deeper, within the quantum circuit model in quantum computing, the performance depends crucially on the fidelity of two-qubit gates. These are typically implemented using microwave or laser pulses, which are computed using quantum optimal control. While it has been traditionally suggested that performance of local-search methods such as Gradient Ascent Pulse Engineering Algorithm (GRAPE) and Chopped Random Basis (CRAB) applied to simple two-qubit Hamiltonians is sufficient, it is increasingly recognised that one could improve the performance substantially by considering methods that provably converge to the global optima and, perhaps even more importantly, consideration of open quantum systems, rather than closed quantum systems is desirable. In the latter, to address issues such as cross-talk, one may need to consider a multi-qubit system, in order to design the pulse implementing a two-qubit model.

Outside of quantum computing, in applications such as the laser control of chemical reactions or coherent population transfer among quantum states of atoms and molecules more broadly, one would naturally like to implement quantum optimal control of many-level systems, but even popular heuristics such as GRAPE and CRAB do not scale sufficiently to be implementable in an efficient manner.

There are numerical treatments that lead to the successful solution of the Schrödinger equation, including considering periodic potentials. A number of these methods are centred around finding ways to reduce the infinite spatial domain. In particular, pseudospectral methods make use of a Fourier basis of test functions to discretize both the temporal and spatial domains, resulting in a fully discrete problem, which is not full applicable to all situations.

Various frequency domain approaches have been tried, but these rely on full discretisation of the frequency space without having any mechanism to limit the domain.

The technological drawbacks with known methods set out above are addressed herein by various technical solutions and corresponding systems for practical application.

### SUMMARY

A heterogenous computing platform approach is proposed herein where a classical computer is configured to control a physical quantum pulse generation circuit to precisely manipulate quantum states of a quantum computer system using controlled magnetic pulses, driving the quantum computer system into a target state using a frequency-domain based harmonic-analytic approach. The computing platform approach uses two physical computers, a classical computer, and a quantum computing device. The quantum computing device can be a quantum computer. The quantum computing device can be provided in an “uninitiated state”, for example (but not necessarily) where all quantum features are at a “zero state”, inhabiting the lowest energy state.

Before the quantum computing device can be used for a practical application, it needs to be driven into an initiated state, and this is conducted through electro-magnetic manipulation of the configurable quantum components of the quantum computing device. The classical computer can conduct a series of computations to identify solutions to map a target state wavefunction specifically in relation to the architecture of the quantum computing device, and then provide an instruction set to a pulse generator. The pulse generator can be on-board the classical computer, or in a variation, it can be external to and coupled to the classical computer. The pulse generator receives the instruction set and creates precise electro-magnetic signals to drive the various qubits and qudit states. Once driven to a specific state corresponding to the original target state, essentially the quantum computing device is ready for quantum computing. For example, the pulse may drive the quantum computing device to target equal superposition states, and a desired technical objective is to be able to achieve these target equal superposition states without unduly increasing computational complexity from a preparation perspective (e.g. get to target equal superposition state cheaply). A contemplated alternative to the pulse generator can also include a transmission line model that provides exact voltages to the quantum computing device and can more accurately drive and excite the qubits or qudits in a precise approach.

As noted herein, generating the instruction set is very technically challenging as the classical computer must computationally derive the solution based on the target state wavefunction. Absent constraints, the potential computational search space can be near infinite and very difficult to solve, from a computational complexity perspective given real life limitations of computing resources and computing time. For these reasons, the technical challenge of scaling computer complexity causes the erosion of the “quantum advantage” if significant computing resources are needed for quantum state preparation of the quantum circuit.

Embodiments proposed herein address the scalability of quantum optimal control methods by considering a frequency-domain approach driving the quantum computer system. A control problem formulation and corresponding control methods and systems are proposed that determines and then imposes artificial boundary conditions for the Schrödinger equation in combination with spectral methods, which then reduces the search space and improves computational efficiency for identifying solutions to the Schrödinger equation.

The resulting formulations are well suited for investigating periodic potentials and lend themselves to direct numerical treatment using conventional methods for bounded domains. The artificial boundary method, is proposed where one attempts to impose artificial boundary conditions on the Schrödinger equation, making it solvable using available numerical methods (finite elements, finite differences, etc.). Imposing these artificial boundary conditions finds utility in a broad range of quantum and non-quantum applications, including non-Markovian open quantum systems.

A core technical improvement is that because the quantum preparation step is improved through the proposed approaches described herein, the quantum advantage is not lost during the state preparation state, and once prepared, the quantum computing device can be run in polynomial time for the practical application, which can include, among others, quantum encryption/decryption, quantum search optimization (for example quantum chemistry), among others.

A proposed innovation is the use of the artificial boundary computing method that is applied during the solving of the solution in frequency space, where the solution is also formulated in frequency space (without requiring re-transformation away from the frequency space). The approach uses computer-driven numerical methods and optimization techniques, such as moment based techniques that are used for discretizing the mathematical representation and conducting local optimization using, for example, gradient descent, stochastic gradient descents, among others. A computer subroutine can be used to solve a forward problem.

The artificial boundary method proposed herein is an artificially imposed constraint that requires additional technical steps for determination thereof, and the constraints are provided to a solver as additional steps prior to the attempt to generate solutions, constraining the processing by the solver to a specific bounded space. Accordingly, the proposed approach is a harmonic-analytic approach to quantum optimal control, which can utilize the Laplace transform and inverse Laplace transform to solve a much smaller problem classically in order to control the quantum system optimally. This leads to a simpler system to solve in most cases, and the simpler system allows for improved computing for a given amount of computing available resources, which is technically important in view of practical processing constraints. The classical computer in addition to the quantum wave generation circuit act as a physical special purpose control unit or circuit module that is coupled to the quantum computer to drive the state of the quantum computer.

To this end, disclosed herein is a method of encoding a target state on a quantum system. Encoding a target state on a quantum system can be practically conducted by identifying and generating a specific pulse that is configured to drive the quantum system into the target state. An example of such a pulse can be used for programming physical quantum states with a control pulse, which can ultimately be generated by a physical pulse generator. When the pulse is received by physical quantum computing hardware, it drives the quantum system into the desired quantum states by modifying quantum operators of the quantum system, such as a Hamiltonian. However, as noted below, pulse-level optimization is a non-trivial task as it is difficult to conduct experimental measurements.

The method includes providing, to a classical computer, a time-dependent Schrödinger equation characterising the properties of the quantum system, wherein the Schrödinger equation has a potential term, V, which includes boundary conditions providing constraints on solutions to the Schrödinger equation, and wherein a control parameter η is provided which allows control of the form of a potential term V, and/or a momentum operator, ∇².

From a computer input perspective, the time-dependent Schrödinger equation is provided in the form of a data object that includes as field values and associated fields, the terms of the Schrödinger equation, such as a tuple data object in accordance with a data object schema. An example data object notation can include an XML data object, a Javascript Object Notation (JSON) data object, but other types of data objects are possible, such as matrix valued NumPy arrays, which may provide a more efficient mechanism for practical storage.

Next, the method includes providing to the classical computer a description of the target state, ψ̅, to be encoded on the quantum system. From a computer input perspective, the description is provided in the form of a target state data object that, can similarly, be a tuple of the characteristic terms of the target state, ψ̅. The target state could be a wavefunction to be encoded into the quantum computing system, and the wavefunction characteristics can form the characteristic terms of the target state, ψ̅. Different wavefunctions are useful in different contexts, such as quantum encryption, decryption, chemistry, among others, and the quantum computing device may need to be prepared from a quantum state perspective before being practically useful to conduct these quantum computing tasks.

The method then includes the classical computer being controlled for formulating a time-domain optimisation problem including the control parameter η as a controllable variable to minimise a difference between a time-varying state of the quantum system, ψ̅(x, t, η), and the target state ψ̅ after a finite time T has elapsed, subject to the limitations imposed by the Schrödinger equation, the boundary conditions, and the initial state of the quantum system; transforming the time-domain optimisation problem into the frequency domain.

The time-domain optimisation problem, in some embodiments, can be practically implemented in the form of an equation to be numerically solved by a computational solver data process being operated on the classical computer, implemented in the form of a series of logical conditions that are required to be met. As noted, a technical challenge noted herein are the challenges with conducting this solving process given a potentially infinite computational search space, which renders traditional approaches impractical given real-world constraints on computer resources and processing capabilities.

Accordingly, as described herein, the classical computer can be configured to algorithmically impose a search space constraint using artificial boundary conditions at this step.

The method then includes the classical computer solving the frequency-domain optimisation problem to identify a form of η which drives the quantum system into the target state ψ̅ within time T, and as noted herein, the artificial boundary condition approach is technically useful in improving the capability of the computer to be able to solve the problem from a practical perspective given limitations on computer processing resources.

The method then includes using the identified form of η to form a pulse to vary V; and/or ∇², which is conducted to provide specific electrical or magnetic signals to manipulate the behaviour of the quantum system (e.g. spin systems, flux rings, etc.).

A pulse is a physical control signal that can be generated by a physical pulse generator module, which can be coupled to the quantum computer system, the physical pulse acting on the electrical or magnetic components of the quantum computing system, for example, by imposing a physical magnetic field on specific data/gate representations of the quantum computing system to modify a physical state of being.

An example pulse can encode a set of circuit control instructions for that enact the specific state transformations when physically driven by the physical pulse generator.

The method then includes applying the pulse to the quantum system to drive the quantum system into the target state ψ̅. From a physical control perspective, applying the pulse to the quantum system means physically providing the control signal to establish a magnetic field. Here, using η to vary V is used in systems where for example an electric or otherwise controllable potential controls the behaviour of the quantum system. Where a magnetic field can be used to vary the behaviour of the quantum system (e.g. spin systems, flux rings, etc.), a transform of the momentum operator, ∇², is used such that ∇²→∇²+ηA, where A is a vector potential of the magnetic field acting on the quantum system and η is a function which controls the form of the resulting magnetic field acting on the quantum system.

By transforming the optimisation problem into the frequency domain, a spectral analysis is possible. This allows, in combination with the imposition of boundary conditions, infinite dimensional problems to be limited to finite dimensional cases. This is important from a practical computational perspective to achieve a practical, implementable solution given real world technical drawbacks and limitations in computing resources. In addition, a spectral analysis allows a user to identify the more relevant components to the task at hand and adapt the process to focus on these, discarding less relevant components, to obtain a good approximation to the target solution, without the complexity of considering the entire model. The spectral variant encapsulates, for example, patterns or symmetries in the underlying physics of the quantum system and allows these to be exploited to arrive at a tractable and efficient solution.

Overall, the methods described herein leverage the frequency domain approach in combination with the setting of boundary conditions to provide a tractably solvable system, the solution of which leads to a physical pulse engineered to drive the quantum computing system into the target state, and the solution can also include the driving of the physical pulse on the quantum computing system. In terms of solving the optimisation problem, there are various options available, such as gradient based convergence methods, numerical approaches and so forth.

In contrast to the aforementioned frequency-domain approached, the proposed approach uses artificial boundary conditions as a mechanism to limit the spatial domain, while still taking advantage of the frequency space transformation for the temporal domain. The reference focuses on the frequency decomposition of the spatial domain, which is motivated by the finite frequency spatial spectrum found in physical chemistry applications. The focus on the frequency decomposition in the temporal domain is motivated by the state preparation and will yield an advantage in cases where the spatial domain does not admit a simple spectral symmetry, which can occur in practical usage scenarios and thus provides a useful technical improvement for practical quantum computing architectures.

The control parameter is directly related to physical variables such as electric potential, magnetic field, etc. so the form of the control parameter allows direct physical control of the quantum state of the quantum system. This allows the resulting form of the control parameter(s) to be formed into a pulse adapted to drive the quantum system into the target state. The pulse is then applied to drive the quantum system into the target state, thereby resulting in a high-fidelity preparation of a given target state on the quantum system. This physical control imposes a magnetic field that can modify the quantum state of the quantum state such that the state approximates the given target state, and thus the quantum computing system is prepared for use for the execution of various quantum computing tasks.

It is important to recognize that pulse formation is technically challenging and complex due to issues associated with pulse precision and spatial considerations. Depending on the spatial configuration of the qubits or qudits of the quantum computing system, a single pulse may affect multiple qubits or qudits that are close to one another, for example, and the solution needs to be solved taking into consideration the spatial configuration of the qubits or qudits. There can be different possible solutions, but it is very challenging to find even one solution given that the form of the equation lends to a near-infinite search space.

Optionally, transforming the time-domain optimisation problem includes applying a Fourier transform or a Laplace transform to the Schrödinger equation, the boundary conditions, and the time-varying state of the quantum system. These transforms can be applied quickly and efficiently. The Laplace transform is particularly suited to the approaches used herein, since fewer inverse transforms will be required to arrive at the output solution.

As proposed herein, the boundary conditions are artificially imposed on the Schrödinger equation. That is to say that rather than the boundary conditions being inherent in the system, their spatial location(s) are chosen freely to adapt the process to the information most relevant to the problem being solved. For example, the spatial location of the boundary conditions may be selected to include a spatial region which captures the essential physics of the quantum system. As described herein, the essential physics relates to a specific computing approach that is configured such that it allows the main features of the quantum system to be factored into the model while discarding less meaningful parts (those outside the boundary conditions) to arrive at an efficiently solvable optimisation problem. Accordingly, the spatial region is computationally derived and used to limit the computational search space required for solving the Schrödinger equation by imposing artificial computing boundary conditions.

As an example, the potential term, V, may be provided in a piecewise manner such that the potential term, V, has a first form in a first region outside the spatial locations of the boundary conditions and a second form in a second region inside the spatial locations of the boundary conditions. This can, for example, allow the potential term, V, to be set at a constant value in the first region and the control parameter, η, to be used to alter the form of the potential term in the second region.

In some examples, the potential term, V, is a periodic potential. This can be useful in encoding target states in atomic and molecular systems, as well as in regular arrays of qubits in a quantum computer. A periodic potential in quantum physics refers to a potential energy function that repeats itself at regular intervals in space.

Optionally, the frequency-domain optimisation problem includes a regularisation function. This assists in suppressing convergence around improper solutions. For example, where there are local minima (or maxima), the regularisation function can be used to ensure that convergence procedures arrive at a true global minimum (or maximum). The regularisation function can be implemented by the classical computer on the output solution.

For convex systems, the regularisation function can be used to guarantee arrival at a global optimum, while even for non-convex systems, convergence is more efficient and less prone to finding local optima when a regularisation function is employed. Equally, the regularisation function can be formed to measure how hard a given version of η is to implement. This can be used to suppress unphysical, or otherwise hard to implement solutions, filtering the space to leave better, or even the best, solutions for the given system and target state. The provisioning of the regularisation function can be conducted in accordance with a variant embodiment where the classical computer includes a regularisation code module that implements the regularisation functions during the solving step.

The method may include the target state for the quantum system being provided by stating the state and the basis in which that state is expressed and calculating the target state. By setting the basis for the state to be encoded, the form of the target state is uniquely defined. This unique form can either be determined by the classical computer as part of the process, or be supplied by a user or from elsewhere. The target state can thus be obtained in the form of a target state data object having fields corresponding to each characteristic and field values corresponding to the value of each of the characteristics in the target state. The target state data object is then instantiated and ready for the classical computer system to use in an attempt to computationally identify a solution that corresponds to the target state, and as described in more detail herein, the solution is converted into specific pulse commands for driving the quantum computing system from an electrical or magnetic perspective such that the quantum computing system has the target state physically imposed.

Optionally, the frequency-domain optimisation problem is a partial differential equation constrained optimisation problem.

Optionally, the quantum system includes a plurality of qubits and/or qudits on a quantum computer. These qubits or qudits can be established using different types of electronic circuits of the quantum computer that utilize different types of electrical and/or magnetic phenomena to represent different states, for example, representing information stored in a superposition of states. The approach proposed herein allows for precise encoding of an initial state on a quantum computer, a critical step in performing high fidelity calculations on quantum hardware. Optionally, the quantum system includes a plurality or transmon or fluxonium qubits. Other quantum computing hardware may be employed with the control provided by η being tailored to the specific physics of the quantum computing hardware.

Optionally, the control parameter is in the form of a polynomial function. For example, the polynomial function may be formed from a sum of products of time dependent control variable with time independent terms representing the available manipulations of the quantum system. Such a form opens up the applicability of various computational methods to solve the optimisation problem. For example, solving the frequency-domain optimisation problem may include applying polynomial and sum-of-squares relaxation techniques. This is a well-understood approach which can be efficiently applied to a wide range of problems.

Optionally, transforming the time-domain optimisation control problem into a frequency-domain optimisation problem uses the Magnus expansion. The Magnus expansion of an operator involves re-writing the operator as an infinite sum of terms. Each term in the sum is evaluated as an integral of increasingly complex nested commutators. However, when the sum is absolutely convergent, the operator is expressable as an exponential, leading to a neat, closed-form solution.

Also disclosed herein is a computer system for encoding a target state on a quantum system, the computer system comprising a classical computer configured to enact the steps of any one of the methods discussed above.

The system may further comprise a quantum system onto which the target state is to be encoded. Optionally, the system may further comprising a pulse generator to supply the pulse. In another variation, instead of comprising the pulse generator, the system can couple to an external pulse generator to provide instruction sets in the form of instruction data objects, and the external pulse generator drives the quantum computing system. This may be constructed or arranged to direct or otherwise supply the pulse generated to the quantum system, thereby to prepare the quantum system in the target state. The end result from preparing the quantum system in the target state is a prepared quantum system that has been physically entrained to represent the target state, and the prepared quantum system is ready for executing quantum computing tasks, such as conducting specific quantum computations for different applied fields such as cryptography, computer based optimisation, discovery, artificial intelligence or machine learning, physics simulations, among others.

Also disclosed herein is a non-transitory computer readable medium comprising machine interpretable instructions which cause a computer to enact the steps of any one of the methods discussed above. The non-transitory computer readable medium is an article of manufacture that can encapsulate a computer program product for execution on a classical computer having computer processors, coupled memory, and data storage, coupled to a pulse generator device that drives the quantum computing system.

### BRIEF DESCRIPTION OF THE DRAWINGS

The invention will now be described in detail with reference to the accompanying Figures, in which:

FIG. 1 is a schematic of the processes set out herein.

FIG. 2 is a flow chart illustrating methods as disclosed herein.

FIG. 3 is a schematic of a system for implementing the methods disclosed herein.

FIG. 4 is a more detailed example block schematic of the system of FIG. 3.

FIG. 5 is an illustration of an approach for establishing multiple artificial boundary conditions, according to an embodiment relating to multiple subsets to further reductions in computational complexity.

### DETAILED DESCRIPTION OF THE INVENTION

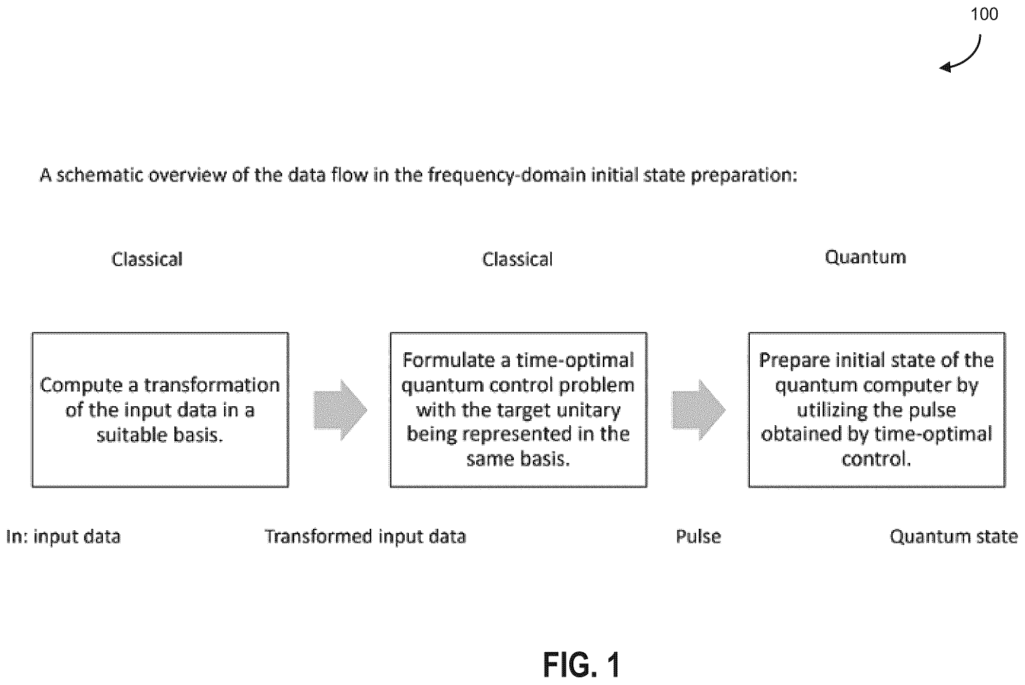

FIG. 1 is a flow diagram representing the methods set out herein. Input data are fed into the computation in the form of data objects into the classical computer, including a description of the target state and the Schrödinger equation capturing the physics of the quantum system on which the target state is to be prepared. Classical computation is used to manipulate the input information in order to provide a tractable solution to the problem. Using a heterogeneous computing architecture having a classical computer and a quantum computing device together in tandem allows for the classical computer to be used as a state preparation device for initializing an uninitialized quantum computing device, and once initialized, the quantum computing device can be used more efficiently for executing quantum computing tasks. As described herein, state preparation is a complex technical problem and it is important to take steps that computationally attempt to reduce the computational complexity of the state preparation, otherwise the computing advantages associated with quantum computing are not possible to be harnessed. R

As described in further detail below, specific practical computing approaches are proposed that aid the computation, in particular, restricting the computational search space to a practically defined space imposed by artificial boundary conditions are proposed herein, providing a proposed technical solution that aids in practical computing. Identifying this solution is non-trivial and requires significant computing resources.

In particular, a transformation is applied to put the input data in a suitable basis to proceed. Transformations described herein include frequency domain transformations, among others. Next, a time-optimal control problem is formulated by the classical computing system such that the target state is represented in the same basis as the transformed input date. Formulation of the time-optimal control problem can be an automated algorithmic process conducted by the classical computing system, formulating the time-optimal control problem in the form of computing syntax and functions, defining the conditions upon which a solution would be satisfactory.

The computational representation of the time-optimal control problem is solved to arrive at a pulse suitable for driving the quantum system into the target state. As described herein, solving the time-optimal control problem is non-trivial, and may require computational numerical methods and optimised libraries to attempt and test different solutions. The search space for the right characteristics of the pulse can be a major technical challenge, and using computational methods may require exhaustive computational solution space searching. Accordingly, as proposed herein, the artificial boundary conditions help constrain the computational solution space searching and provide an innovative approach for the solving step.

The determined pulse can have specific characteristics for driving the quantum system, such as amplitudes, frequencies, timing, among others. The pulse electrical components determined by the classical computer are physically implemented in the form of specific and precise electromagnetic pulses that interact with the qubits or qudits of the quantum computing system.

Finally, this pulse is applied to the quantum system, causing the quantum system to be driven into the target state. As an example, the quantum system may be a series of qubits (or, more generally, qudits) on a quantum computer, and the initial state may correspond to an initial state of the quantum computer from which a calculation or the execution of a computing instruction on the quantum computer is to proceed. In other examples, the quantum system may be a molecule or other matter-based system, which is to be prepared into a known target state, for example to control chemical reactions or alter the electronic properties of the quantum system.

The time optimal control problem utilises a frequency-domain approach. In particular the control problem formulation makes use of artificial boundary conditions for the Schrödinger equation in combination with spectral methods. The resulting formulations are well suited for practical usage for investigating periodic potentials and lend themselves to direct numerical treatment using methods for bounded domains.

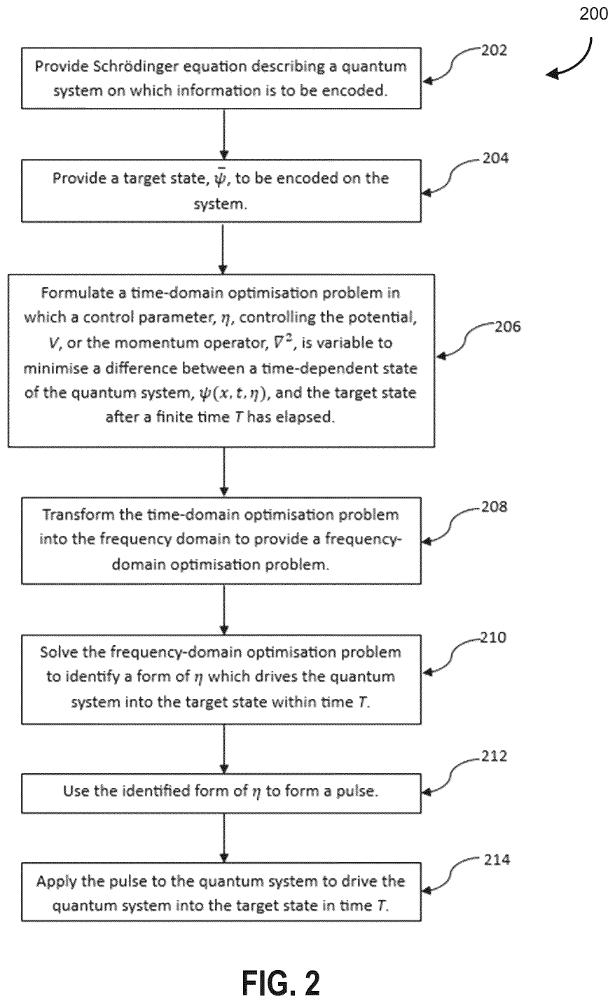

A more detailed explanation of the method can be seen in FIG. 2. Here, a method 200 includes a series of steps to enact the processes described herein. The process provides a numerically treatable semi-spectral method for optimising state preparation. Due to the chosen method of derivation, the artificial boundary conditions are shown to be directly translatable to the semi-spectral form.

To this end, the method begins at step 202, in which a Schrödinger equation characterising the properties of the quantum system is input to the calculation. The calculation can be conducted by the classical computer, for example being provided to a data receiver such as a data input terminal or a file receiver as a data object. The data object includes representations that capture the physics and time evolution properties of the quantum system which is to be prepared in a given state, and is used for identifying suitable pulses.

The Schrödinger equation has a potential term, V. The Schrödinger equation also includes boundary conditions providing constraints on solutions to the Schrödinger equation. The boundary generally be artificially imposed on the system to restrict the space from an infinite one. As described herein, the boundary conditions can be defined by the classical computer at a boundary condition determination module, converted into instruction sets, and then the instruction sets can be used to impose as constraints on a solver computing module such that the solver computing module only conducts numerical or computational solving on a reduced search space.

The use of a frequency-domain approach in conjunction with artificial boundary conditions (or equally, considering the sub-class of problems which transform to a bounded problem, thereby avoiding the need for artificial boundary conditions), a useful practical implementation of the present approach.

In order to control the state of the system, a control pulse will be formed. A control pulse is a physical pulse that is generated, for example, by a specific pulse generator circuit. This process is used for altering the state of the system, and can include different physical approaches such as such as e.g. microwave pulses, magnetic field manipulation and so forth. These are represented in the optimisation problem by modifying the Schrödinger equation using a control parameter which can be freely varied (within the limits of physical possible forms), the form of which is optimised by the process to drive the system into a target state. Optimisation, in the context of a pulse, is defined as the pulse having physical characteristics that can be used to instantiate very specific quantum operations that impact the quantum space. The pulses are pulse level instructions for precise manipulation of magnetic states, such as superpositions, entanglements, and the pulses can be shaped and/or timed to have precise amplitudes, phase characteristics, among others for qubit manipulation. The amplitude determines the strength of the interaction, while the phase controls the timing and coherence of the quantum operations.

The control parameter, η, is provided in a form which allows control of the form of a potential term V, and/or a momentum operator, ∇², with the former being a more widely applicable case, and the momentum operator variant being used to affect magnetic fields applied to the system. Specifically, the alterations to each term when the control parameter is included are V(r)→V(r, η(r, t)) and ∇²→∇²+η(r, t)A. By altering the form of the Schrödinger equation in this way, a controllable parameter has been introduced which can be manipulated via optimisation processes to identify forms for that control parameter which drive the system toward (and eventually into) the target state after a time T. Since the control parameter relates to real, physically-alterable parameters, this directly couples the optimisation process to the form of pulse needed to drive the system into the target state. The solving process can include numerically solving for the controllable parameter by the classical computer.

The 3D, time-dependent Schrödinger equation may be written as:

$$i ℏ \frac{\partial }{\partial t} ψ ( r , t ) = [ - \frac{{ℏ}^{2}}{2 m} ( {∇}^{2} + {η}_{1} ( r , t ) A ) + V ( r , t , {η}_{2} ( r , t ) ) ] ψ ( r , t )$$

where one of η₁ and η₂ can be set to 0 where the corresponding control does not apply (e.g. where magnetic control is not desired or is not possible, η₁=0).

Boundary conditions are defined by the classical computing system and then provided artificially to a solver module implementing the Schrödinger equation to constrain the spatial region being considered from an infinite region to a finite space, improving the technical functioning of the solver module in an attempt to achieve reasonable performance given practical computing constraints.

The choice of spatial location of the boundary conditions is a technical improvement that is adapted to allow a computational simplification of the problem without losing resolution, effectively enforcing an artificial complexity reduction. That is to say that rather than the boundary conditions being inherent in the system, their spatial location(s) are chosen freely to adapt the process to the information most relevant to the problem being solved. For example, the spatial location of the boundary conditions may be selected to include a spatial region which captures the essential physics of the quantum system (i.e. including at least individual elements or each element of the quantum system, and a region surrounding the elements). This allows the main features of the quantum system to be factored into the model while discarding less meaningful parts (those outside the boundary conditions) to arrive at an efficiently solvable optimisation problem.

In some embodiments, different variations are possible in the artificial boundary conditions, with differing amounts of main features being factored into the model and differing amounts being discarded. In a variation of the approach, a plurality of boundary conditions can be identified, each with different strictness levels in terms of features to be retained or discarded, and if an efficiently solvable optimisation cannot be found given the amount of computing resources, a next stricter approach is considered or implemented until a solution is found. In this variation, the approach can be tailored based on the amount of computing resources, which may not be known a priori, or in some cases, dynamically available depending on other computing tasks being performed by the computing system.

The boundary condition is selected by the classical computing system using two considerations: the shape of the domain and the features of the system which are of interest to the analysis. Consider, for example, a simple example of the particle in a box. Here, the potential of the quantum system increases dramatically at the location of the walls of the box. Placing the boundary condition at some point outside the walls is suitable, since it is assumed that the particle does not escape the box.

Note that in this example, there is little difference in terms of the accuracy of the calculation between placing the boundary condition outside, but close to the walls, and placing the boundary conditions at ±∞. In more complicated systems, there is usually a technical trade-off between the desired accuracy of the calculation on the one hand, and the computability of a solution on the other hand.

This translates into the accuracy with which the target state is achieved at the end of the process, and ultimately into the fidelity with which, e.g. a calculation starting from that state can be carried out, the desired chemical reaction can be engineered, etc. The specific target state and the use to which that state is to be put will put lower limits on a suitable level of accuracy, which can then be used to inform the choice of location of artificial boundary conditions, and thereby to determine the extent to which accuracy and computational resources should be traded off against one another. The specifics of boundary condition formation are discussed in more detail below.

At step 204, a description of the target state, ii, to be encoded on the quantum system is provided to the classical computer. This step can be performed simultaneously with step 202 or before even before step 202. As noted above, the target state represents the state which the quantum system is intended to be driven into. The target state therefore represents an expression of specific quantum states for elements of the quantum system as a whole. This will express the information on the state in a particular basis (usually chosen as a basis which is convenient for efficiently expressing the state). In some examples, the target state may be calculated as part of the process by deciding on a basis and calculating the expression of the state mathematically in that basis. In other cases, the target state may be provided independently from another process.

In whichever manner the target state is supplied, the tying of the state to a given basis uniquely represents that state.

Once both the Schrödinger equation and the target state have been received, the method proceeds to step 206. Here, a time time-domain optimisation problem is formulated, in which the control parameter η is variable to minimise a difference between a time-varying state of the quantum system, ψ(x, t, η), and the target state ψ̅ after a finite time T has elapsed, subject to the limitations imposed by the Schrödinger equation, the boundary conditions, and the initial state of the quantum system. The problem can be addressed, for example, by computationally varying the control parameter.

Even though the presented techniques apply to a spatial domain of any fixed dimension i.e. [symbol] ⁿ, the following discussion is kept simple by assuming that n=1. Let ψᵢₙᵢ∈L²( [symbol] ) be a compactly supported initial condition and V: [symbol] × [symbol] ₀⁺→ [symbol] be a potential, which satisfies:

$$V ( x ) = \{ \begin{matrix}{V}_{l} & for x \leq {x}_{l} \\ {V}_{r} & for x \geq {x}_{r}\end{matrix}$$

where xₗ, xᵣ∈ [symbol] . The quantum system of interest is described by the Schrödinger equation:

$$i \frac{\partial ψ ( x , t )}{\partial t} = - \frac{{\partial }^{2} ψ ( x , t )}{\partial {x}^{2}} + V ( x , t ) ψ ( x , t )$$

where (x, t)∈ [symbol] × [symbol] ₀⁺, and subject to

$${lim}_{\vert x \vert \to + ∞} ψ ( x , t ) = 0$$

for all t∈ [symbol] ₀⁺ and ψ(x, 0)=ψᵢₙᵢ(x) for all x∈ [symbol] .

The control term is introduced into this system by providing a potential which is variable by a control parameter, η, i.e. V(x, t)=V(x, t, η), where η is a finite or infinite dimensional control parameter belonging to a control set, C. Additionally, there exist spatial locations given by real numbers \hat{x}ₗ and \hat{x}ᵣ such that, for all η:
(x, t, η) is constant on (−∞, \hat{x}ₗ) and (\hat{x}ᵣ, ∞)

This finding allows a spatial location at which the artificial boundary conditions are imposed.

To derive artificial boundary conditions for this equation the spatial domain is divided into two parts:

$${Ω}_{i n} = ( {x}_{l} , {x}_{r} ) and {Ω}_{o u t} = ( - ∞ , {x}_{l} ) ⋃ ( {x}_{r} , + ∞ )$$

resulting in the coupled system (in natural units where ℏ=1):

$$i \frac{\partial v}{\partial t} + \frac{{\partial }^{2} v}{\partial {x}^{2}} = Vv on {Ω}_{in} \times {ℝ}_{0}^{+}$$

$$\frac{\partial v}{\partial x} = \frac{\partial w}{\partial x} on \{ {x}_{l} , {x}_{4} \} \times {ℝ}_{0}^{+}$$

$$v = {ψ}_{i n i} on {Ω}_{i n} \times \{ 0 \}$$

$$i \frac{\partial w}{\partial t} + \frac{{\partial }^{2} w}{\partial {x}^{2}} = Vw on {Ω}_{out} \times {ℝ}_{0}^{+}$$

$$v = w on \{ {x}_{l} , {x}_{r} \} \times {ℝ}_{0}^{+}$$

$${lim}_{\vert x \vert \to + ∞} w ( x , t ) = 0 , for all t ∈ {ℝ}^{+}$$

$$w = 0 on {Ω}_{o u t} \times \{ 0 \}$$

where v and w are the respective solutions on the interior Ωᵢₙ and exterior Ωₒᵤₜ of the full spatial domain [symbol] . If v and ∂v/θx (or equivalently w and ∂w/∂x) are such that the above system is well posed the can be denoted as boundary conditions absorbing (ABC). If the boundary conditions yield a solution that coincides with the original problem, these boundary conditions can be denoted as transparent (TBC). From a computing perspective, once derived, the artificial boundary conditions can be represented in the form of a boundary condition data object that is stored for use by a solver. When the solver process executes, the artificial boundary conditions are processed and used for limiting the search scope.

A transparent boundary condition for the above Schrödinger equation can be derived. As an initial step, it is noted that:

$${Ω}_{l} = ( - ∞ , {x}_{l} ) , {Ω}_{r} = ( {x}_{r} , + ∞ )$$

This description will return to this in step 208.

A further definition of parameters is in the control set. This has various possible formulations, but breaks down broadly into two classes. The first of these may be derived as follows. First, assume that there is no a priori assumption on the form of the potential, V, while still imposing the limitation that the potential is constant outside of the spatial locations \hat{x}ₗ and \hat{x}ᵣ.

Using the existence result for the Schrödinger equation, the following control sets may be considered:

$${C}_{h o m}^{{\hat{x}}_{l} {\hat{, x}}_{r}} = \{ V ∈ C ( {ℝ}_{0}^{+} , {L}^{∞} ( ℝ ) ) : V = 0 for x ∈ ( - ∞ , {x}_{l} ) ⋃ ( {x}_{r} , + ∞ ) , for any t ∈ {ℝ}_{0}^{+} \}$$

$${C}^{{\hat{x}}_{l} {\hat{, x}}_{r}} = \{ V ∈ C ( {ℝ}_{0}^{+} , {L}^{∞} ( ℝ ) ) : V = constant for on x = ( - ∞ , {x}_{l} ) and ( {x}_{r} , + ∞ ) , for any t ∈ {ℝ}_{0}^{+} \}$$

where notably both of these sets are convex sets of the Banach space, C( [symbol] ₀⁺, L^{∞}( [symbol] )), which ensures the existence of a solution in the Banach space for any such control.

[symbol]

In the second approach, the potential is assumed to have a specific structure, based on knowledge of the quantum system. Taking a simple example of the driven quantum harmonic oscillator, the potential is known to be:

$$V ( x , t ) = \frac{{ω}^{2} ( t ) {q}^{2} ( x , t )}{2 m} - \tilde{J} ( x , t ) q ( x , t )$$

in which ω is the angular velocity, q is the particle's position, and \tilde{J} is a bounded function describing the drive of the oscillator.

A correction term is incorporated so that the potential is constant outside of the spatial locations \hat{x}ₗ and \hat{x}ᵣ, i.e. \tilde{J}(x,t)=J(t)+R(x,t), in which J is the physically accurate driving function. Here the correction term is given by:

$$R ( x , t ) = \frac{1}{x ( t )} [ {x}_{r} + \frac{{ω}^{2} ( t ) {q}^{2} ( x , t )}{2 m} J ( t ) ] for x ∈ ( {x}_{r} , + ∞ )$$

$$0 for x ∈ ( {x}_{l} , {x}_{r} )$$

$$\frac{1}{x ( t )} [ {x}_{1} + \frac{{ω}^{2} ( t ) {q}^{2} ( x , t )}{2 m} J ( t ) ] for x ∈ ( - ∞ , {x}_{l} , )$$

Since the above equation needs to be imposed to ensure that the left and right artificial boundary conditions remain at the spatial points xₗ,xᵣ, respectively, it is clear that the drive J cannot have an arbitrary form.

To guarantee the existence of solution, J must be chosen so that the above potential term of class C( [symbol] ₀⁺, L^{∞}( [symbol] )). Using this example, one may define the control set as

$${C}_{spec} = J ∈ {L}^{2} ( {ℝ}_{0}^{+} ) : ∃ R ∈ {L}^{∞} ( {ℝ}_{0}^{+} , {L}^{∞} ( ℝ ) )$$

such that

$$V = J + R ∈ C ( {ℝ}_{0}^{+} , {L}^{∞} ( ℝ )$$

The convexity of such a set is problem dependent.

As can be seen from the above examples, the potential term, V, may be provided in a piecewise manner such that the potential term, V, has a first form in a first region outside the spatial locations of the boundary conditions and a second form in a second region inside the spatial locations of the boundary conditions. This can, for example, allow the potential term, V, to be set at a constant value in the first region and the control parameter, η, to be used to alter the form of the potential term in the second region. Appropriate matching of the value and gradient of the potential at the boundaries can be implemented as a constraint.

In some examples, the potential term, V, is a periodic potential. A periodic potential can be useful in encoding target states in atomic and molecular systems, as well as in regular arrays of qubits in a quantum computer.

In some examples, the control parameter η is provided in the form of a polynomial function. For example, the polynomial function may be formed from a sum of products of time dependent control variable with time independent terms representing the available manipulations of the quantum system. Such a form opens up the applicability of various computational methods to solve the optimisation problem. For example, solving the frequency-domain optimisation problem may include applying polynomial and sum-of-squares relaxation techniques. This is an approach which can be efficiently applied to a wide range of problems.

Taking the above discussion, a direct formulation of the optimisation problem is possible.

Next, at step 208, the method proceeds to transform the control problem set out above into the frequency domain. Various options for implementing this are available, with two main options being the Fourier transform:

$$ℱ \{ ξ \} = {\int }_{- ∞}^{∞} f ( x ) {e}^{- i 2 πξ x} dx$$

and the Laplace transform:

$$ℒ \{ f \} ( s ) = {\int }_{0}^{∞} f ( t ) {e}^{- st} dt$$

While each is applicable here, with analogous steps implemented in each, the discussion below focusses on the Laplace transform, because the method involves one fewer inverse transform to implement fully, and is therefore generally more efficient. It should be noted that where the Laplace transform is discussed below, replacing with the Fourier transform would lead to similar results.

Taking the transparent boundary conditions on Ωₗ and Ωᵣ given above, we can transform these with respect to time using the unilateral Laplace transform. Applying this to Ωᵣ the following is obtained:

$$is \hat{w} + \frac{{\partial }^{2} \hat{w}}{\partial {x}^{2}} = {V}_{r} \hat{w} where x ∈ {Ω}_{r} , s ∈ ℂ$$

with Vᵣ denoting the constant value of V on Ωᵣ. This differential equation has a solution:

$$\hat{w} ( x , s ) = {c ( s )}^{+} {e}^{\sqrt{- is + {V}_{r}} x} + {c ( s )}^{-} {e}^{- \sqrt{- i s + {V}_{r}} x} where x ∈ {Ω}_{r} , s ∈ ℂ$$

A physical solution of the equation must be such that the real part of \sqrt{−is+Vᵣₓ} is positive and so

$$\hat{w} ( x , s ) ∈ {L}^{2} ( {Ω}_{r} ) ⇒ {c ( s )}^{+} = 0$$

The functions v and w are identical on the boundary by design of the optimisation problem, and so (using the continuity of the solution up to the boundary) we get:

$$\hat{w} ( x , s ) = {e}^{\sqrt{- i s + {V}_{r}} ( x - {x}_{r} )} \hat{v} ( {x}_{r} , s )$$

Taking the derivative of this with respect to the spatial dimension, we see:

$$\frac{\partial }{\partial x} \hat{w} ( x , s ) {\vert}_{x = {x}_{r}} = - \sqrt{- is + {V}_{r}} \hat{v} ( {x}_{r} , s ) = - \sqrt{- i s + {V}_{r}} \hat{w} ( {x}_{r} , s )$$

An analogous procedure leads to the condition for the left boundary, which reads:

$$\frac{\partial }{\partial x} \hat{w} ( x , s ) {\vert}_{x = {x}_{l}} = - \sqrt{- is + {V}_{l}} \hat{v} ( {x}_{l} , s ) = - \sqrt{- i s + {V}_{l}} \hat{w} ( {x}_{l} , s )$$

Applying the inverse Laplace transform ( [symbol] ⁻¹) and recalling the initial phrasing of the (time-domain) optimisation problem yields the formulation:

$$i \frac{\partial v}{\partial t} + \frac{{\partial }^{2} v}{\partial {x}^{2}} = Vv on {Ω}_{in} \times {ℝ}_{0}^{+}$$

$$\frac{\partial v}{\partial x} = {ℒ}^{- 1} ( f ) on \{ {x}_{l} , {x}_{r} \} \times {ℝ}_{0}^{+}$$

$$v = {ψ}_{i n i} on {Ω}_{i n} \times \{ 0 \}$$

$$where$$

$$f ( x , s ) = - \sqrt{- i s + {V}_{r}} \hat{v} ( x , s ) {\vert}_{x = {x}_{r}} x = {x}_{r}$$

$$\sqrt{- i s + {V}_{l}} \hat{v} ( x , s ) {\vert}_{x = {x}_{l}} x = {x}_{l}$$

Note that the presented approach is not limited to the case of a constant potential V. In particular, the method above may be generalised to linear, piecewise constant and even periodic potentials.

At this point it is possible to formulate a direct control problem and represent it computationally. Taking the target state, ψ̅∈L²(Ωᵢₙ), into which the quantum system will be driven in time T>0, an optimisation problem is formulated as follows, in view of the preceding equations:

$${min}_{η} [ \frac{α}{p} {\int }_{{Ω}_{i n}} {\vert v ( x , T ; η ) - \overline{ψ} ( x ) \vert}^{p} dx + \frac{β}{q} {\int }_{ℝ \times {ℝ}_{0}^{+}} {μ ( η ( x , t ) )}^{q} d ( x , t ) ]$$

subject to:

$$i \frac{\partial v}{\partial t} + \frac{{\partial }^{2} v}{\partial {x}^{2}} = V ( η ) v on {Ω}_{in} \times {ℝ}_{0}^{+}$$

$$\frac{\partial v}{\partial x} = {ℒ}^{- 1} ( f ( η ) ) on \{ {x}_{l} , {x}_{r} \} \times {ℝ}_{0}^{+}$$

$$v = {ψ}_{i n i} on {Ω}_{i n} \times \{ 0 \}$$

$$i \frac{\partial w}{\partial t} + \frac{{\partial }^{2} w}{\partial {x}^{2}} = V ( η ) on {Ω}_{out} \times {ℝ}_{0}^{+}$$

$$w = {ℒ}^{- 1} ( g ( η ) ) on \{ {x}_{l} , {x}_{r} \} \times {ℝ}_{0}^{+}$$

$${lim}_{\vert x \vert \to + ∞} w ( x , t ) = 0 , for all t ∈ {ℝ}^{+}$$

$$w = 0 on {Ω}_{o u t} \times \{ 0 \}$$

in which p and q are integers which determine the p-norm of their respective distance function, α and β are regularisation strengths for their respective functions.

The parameter μ:C→ [symbol] ₀⁺ is used to capture the cost of the control. The form of μ can also be used to penalise unphysical or undesirable (e.g. costly to implement) solutions to the form of the control parameter η.

While not strictly necessary (and thus proposed as a variant embodiment), this regularisation parameter helps to ensure that the optimisation routine converges on a global minimum. In physical terms, this means that the parameter η brings the quantum system as close as possible to the target state within time T. Finally,

$$g ( η ) = {e}^{- \sqrt{- is + {V}_{r}} ( x - {x}_{r} )} \hat{v} ( {x}_{r} , s ) .$$

Assuming controllability of the system, it is possible to impose the constraint that ψ̅(⋅, T)=v(⋅, T).

It should be noted that the formulation of the above optimisation problem is designed to be numerically solvable. For example, one could use a direct optimization method and solve the problem on Ωᵢₙ for a given control η and then draw upon the analytical solution for the problem on Ωₒᵤₜ (this is possible due to the convenient form of the potential on Ωᵢₙ). In addition, the problem has been established in terms that allow for reformulation in terms of spectral methods. As will be seen below, it remains numerically treatable even after transformation into frequency space.

The transform of the optimisation problem into the frequency domain results in the following semi-spectral variant of the optimisation problem:

$${min}_{η} [ \frac{α}{p} {\int }_{{Ω}_{i n}} {ℒ}^{- 1} {\vert \hat{v} ( s , T ; η ) - \overline{ψ} ( x ) \vert}^{p} dx + \frac{β}{q} {\int }_{ℝ \times {ℝ}_{0}^{+}} {μ ( η ( x , t ) )}^{q} d ( x , t ) ]$$

subject to:

$$is \hat{v} + \frac{{\partial }^{2} \hat{v}}{\partial {x}^{2}} = ℒ ( V ( η ) v on {Ω}_{in} \times {ℝ}_{0}^{+}$$

$$\frac{\partial \hat{v}}{\partial x} = f ( η ) on \{ {x}_{l} , {x}_{r} \} \times {ℝ}_{0}^{+}$$

$$v = \frac{1}{s} {ψ}_{i n i} on {Ω}_{i n} \times \{ 0 \}$$

$$is \hat{w} + \frac{{\partial }^{2} \hat{w}}{\partial {x}^{2}} = ℒ ( V ( η ) w ) on {Ω}_{out} \times {ℝ}_{0}^{+}$$

$$\hat{w} = g ( η ) on \{ {x}_{l} , {x}_{r} \} \times {ℝ}_{0}^{+}$$

$${lim}_{\vert x \vert \to + ∞} \hat{w} ( x , t ) = 0 , for all t ∈ {ℝ}^{+}$$

$$\hat{w} = 0 on {Ω}_{o u t} \times \{ 0 \}$$

Published results allow the above formulation to be derived for periodic potentials as well. For periodic potentials, the semi-spectral variant of the optimisation problem above produces straightforward algebraic expressions in place of the potentials set out above.

In addition, as an optional extension in another variant embodiment, the control and cost functional can be reformulated using a unilateral Laplace transform, giving:

$${min}_{η} [ \frac{α}{p} {\int }_{{Ω}_{i n}} {\vert \hat{v} ( x , T ; \hat{η} ) - ℒ ( \overline{ψ} ( x ) ) \vert}^{p} dx + \frac{β}{q} {\int }_{ℝ \times {ℝ}_{0}^{+}} {\hat{μ} ( \hat{η} ( x , t ) )}^{q} d ( x , t ) ]$$

in which \hat{η} indicates the control in frequency space and is an alternate measure to weight the costing of the control.

By transforming the optimisation problem into the frequency domain in this way, spectral analyses are possible. This allows, in combination with the imposition of boundary conditions, infinite dimensional problems to be limited to finite dimensional cases, which is very important for practical implementation for practical quantum computing devices suitable for practical real-world application.

In addition, a spectral analysis allows a user to identify the more relevant components to the task at hand and adapt the process to focus on these, discarding less relevant components, to obtain a good approximation to the desire solution, without the complexity of considering the entire model. In addition, the underlying physical symmetries and other patterns can be identified and leveraged to cast the computational problem in more suitable terms for solving.

As can be seen form the above, the frequency-domain optimisation problem may be written as a partial differential equation constrained optimisation problem. This procedure can be solved using a solver computing process.

Once the optimisation problem has been provided in the frequency domain, it is ready to be solved. There are various options available at this stage, such as gradient based convergence methods, numerical approaches and so forth. The result of this step is to identify a form of η which drives the quantum system into the target state ψ̅ within time T.

Next, at step 212, the identified form of η is used to form a pulse to vary V; and/or ∇². With this pulse form in hand, the method can proceed to step 214 in which the pulse is generated and applied to the quantum system to drive the quantum system into the target state ψ̅.

In the following section, there are presented some worked examples to illustrate practical applications of the above principles, discussing the motivations for frequency domain approaches, working through the Hamiltonian for two examples (the transmon qubit and the fluxon qubit) and finally illustrating an encoding scheme to identify the target state for a given input.

### Frequency Domain

Many quantum algorithms require an even superposition as the initial state on which the computation is performed. For a two qubit system, this state may be represented as:

$$\vert {ψ}_{initial} 〉 = \frac{1}{2} ( \vert 00 〉 + \vert 01 〉 + \vert 10 〉 + \vert 11 〉 )$$

where |ψᵢₙᵢₜᵢₐₗ [symbol] denotes a target state for the optimization (which is the initial state for the actual quantum computation). The matrix for the Quantum Fourier transform with respect to the canonical basis for a two qubit system reads

$${F}_{2} = \frac{1}{2} [ \begin{matrix}1 & 1 & 1 & 1 \\ 1 & i & - 1 & - i \\ 1 & - 1 & 1 & - 1 \\ 1 & - i & - 1 & i\end{matrix} ]$$

One may notice that

F₂|ψᵢₙᵢₜᵢₐₗ [symbol] =|00

[symbol]

which reveals that the target vector in frequency space may be captured with the use of only a single basis vector instead of four. Assuming now that the approach include only this basis vector from the frequency space, which already contains the target state, the approach may then “add harmonics” i.e. the vectors that form an orthogonal basis which include the vector

$$\vert {ψ}_{initial} 〉 = {\frac{1}{2} [ \begin{matrix}1 \\ 1 \\ 1 \\ 1\end{matrix} ]}_{canonical} = {[ \begin{matrix}1 \\ 0 \\ 0 \\ 0\end{matrix} ]}_{frequecy space}$$

Using this process, the system controls the numerical extent of the problem, while always including the target state. In many cases, quantum systems exhibit symmetries within the frequency domain, this results in a small number of harmonics being sufficient to solve the problem accurately.

### The Transmon Qubit

A common formulation of the Hamiltonian for a superconducting transmon qubit reads:

$${H}_{transmon} = 4 {{E}_{C} ( \hat{n} - {n}_{g} )}^{2} - {E}_{J} cos ( \hat{φ} )$$

where the observables are the phase operator \hat{φ} and the charge operator n satisfying the canonical commutation relation [\hat{n}, \hat{φ}]=iℏ. The value n_{g} gives the equilibrium charge value, charging and Josephson energies are denoted E_{C} and E_{J}, respectively and one can relate the electron charge e and total capacitance C_{Σ} with the charging energy by:

$${E}_{C} = \frac{{e}^{2}}{2 {C}_{\sum }}$$

Relating this formulation to the preceding chapters, one can also split the Hamiltonian into the potential and momentum operator parts by defining:

$$P ( \hat{n} ) = 4 {{E}_{C} ( \hat{n} - {n}_{g} )}^{2} ; Q ( \hat{φ} ) = - {E}_{J} cos ( \hat{φ} )$$

and thus

$$H = P ( \hat{n} ) + Q ( \hat{φ} )$$

To finish the formulation of the Schrödinger equation in coordinate space a transformation into a “phase basis” is considered. Using this technique, the phase operator \hat{φ} becomes a position variable and the charge operator \hat{n} becomes

$$- i \frac{\partial }{\partial φ} .$$

This effort culminates in a form of the Schrödinger equation, which reads:

$$[ 4 {{E}_{C} ( - i \frac{\partial }{\partial φ} - {n}_{g} )}^{2} - {E}_{J} cos ( \hat{φ} ) ] ψ ( φ , t ) = i ℏ \frac{\partial }{\partial t} ψ ( φ , t )$$

where the (complex-valued) wave function additionally satisfies a periodic condition ψ(φ, t)=ψ(φ+2kπ, t). It is possible to engineer the surrounding circuitry of a transmon qubit in such a way that E_{C} and E_{J} may be controlled within a given range. The formulation of the transparent boundary conditions for the above Schrödinger equation has been investigated. This directly leads to a control problem of the type discussed above which can be reformulated as a semi spectral variant as noted above, where the control set is θ=E_{J}. As discussed above, the approach may extend the formulation to include the control of E_{C}, which results in the control set θ=(E_{J},E_{C}), which leads to the ability to control the ratio

$$\frac{{E}_{J}}{{E}_{C}} .$$

This impacts the energy spectrum, especially at the higher levels.

### The Fluxonium Qubit

Following the same approach, the fluxonium qubit can be treated. In contrast with its transmon counterpart, the fluxonium qubit has an additional control parameter, induced by a magnetic field, which is the consequence of adding multiple Josephson junctions into the circuit.

The Hamiltonian in the case reads:

$${H}_{fluxonium} = 4 {{E}_{C} ( \hat{n} - {n}_{g} )}^{2} - {E}_{J} cos ( \hat{φ} + {φ}_{ext} ) + \frac{1}{2} {E}_{L} {\hat{φ}}^{2}$$

where φₑₓₜ relates to the external magnetic flux and E_{L} is the inductive energy of the qubit. Just like in the case of the transmon qubit, the Schrödinger equation can be derived and reads:

$$[ 4 {{E}_{C} ( - i \frac{\partial }{\partial φ} - {n}_{g} )}^{2} - {E}_{J} cos ( \hat{φ} + {φ}_{ext} ) + \frac{1}{2} {E}_{L} {\hat{φ}}^{2} ] ψ ( φ , t ) = i ℏ \frac{\partial }{\partial t} ψ ( φ , t )$$

Treating the boundary conditions like before, one arrives at a control problem formulation with the control sets θ=E_{J} or θ=(E_{J}, E_{C}, φₑₓₜ), depending on the whether the control set includes the variation of the magnetic field or not.

### Preparing a State for Encoding

To detail the application of the proposed frequency domain based optimization a particular example of achieving an initial state for a computation on a quantum computer is presented.

This example serves only as an illustration of a possible application and does not exclude the application of the method to different quantum systems, in which the initial data may not be subject to the qubit interpretation.

For clarity, the procedure is detailed using a single qubit system, but extends readily to a multi qubit system, which is discussed subsequently.

Let |ψ_{target} [symbol] ∈ [symbol] ² be the target state satisfying the usual norm condition ∥ψ_{target} [symbol] =1. More explicitly, one may then assume that there exist α, β∈ [symbol] ² such that:

$$\vert {ψ}_{target} 〉 = α \vert 0 〉 + β \vert 1 〉$$

where the norm condition reads |α|²+|β|²=1 and |0 [symbol] , |1 [symbol] are a basis of [symbol] ²

The above form of target state holds for transmon qubit systems in which the transmon qubit system has a discrete energy spectrum and its eigenvalues may be approximated as:

$${E}_{n} \approx ℏ {ω}_{0} ( n + \frac{1}{2} ) - \frac{{E}_{c}}{12} ( 6 {n}^{2} + 6 n + 3 )$$

where ℏ denotes the Planck constant. Due to this form of energy spectrum it is possible to manipulate the spacing between the energy levels by means of E_{C}. Any state |φ [symbol] may be written in the countable eigenbasis as:

$$\vert φ 〉 = {\sum }_{i = 1}^{∞} {a}_{i} \vert i 〉$$

where |i [symbol] are the eigenstates of the Hamiltonian. It is common practice to construct transmon qubits, such that only the first two energy levels are accessible, which validates the use of the two dimensional model, which makes use of the space [symbol] ² instead of the infinite dimensional separable Hilbert space in which the state |φ [symbol] is found.

Using these assumptions and the fact that the state |ψ_{target} [symbol] =α|0 [symbol] +β|1 [symbol] may also be considered to be an element of this larger Hilbert space if we interpret the basis vectors |0 [symbol] and |1 [symbol] as eigenvectors of the Hamiltonian, the target state represents a valid element within the solution space of the Schrödinger equation.

Applying the Laplace transform gives:

$$\overline{ψ} = {ℒ}^{- 1} ( {ψ}_{initial} ) = {αℒ}^{- 1} ( \vert 0 〉 ) + β {ℒ}^{- 1} ( \vert 1 〉 )$$

which is the target state for the semi-spectral problem.

To extend this construction to the case of the multi qubit setting, one only needs to consider target states that are a tensor product of constituent states and consider a tensor product solution space for the Schrödinger equation also. In this setting, the aforementioned steps may be repeated.

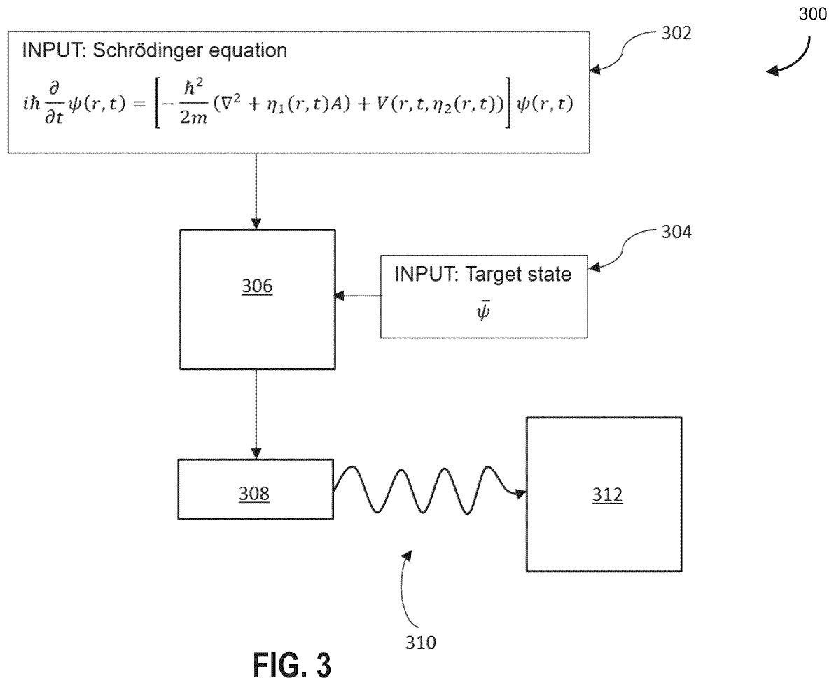

In FIG. 3, a system 300 for implementing the above method is shown. Here an input 302 is shown in the form of the Schrödinger equation describing the physics of the quantum system 312 on which a target state (provided as input 304), is to be encoded. These inputs 302, 304 are provided as data inputs into a classical computer 306 which enacts the above method to provide a form for a pulse which is suitable for driving the quantum system 312 into the target state 304 in time T. This form is provided as an instruction to a pulse generator 308 which generates a pulse 310 in accordance with the instruction. The pulse is arranged to direct or otherwise supply the pulse generated to the quantum system 312, thereby to prepare the quantum system 312 in the target state 304.

The quantum system 312 may be a plurality of qubits and/or qudits on a quantum computer. This allows for the above methods to be enacted to provide precise encoding of the initial state 304 on a quantum computer, a critical step in performing high fidelity calculations on quantum hardware. The quantum system 312 may include a plurality or transmon or fluxonium qubits. Other hardware may be employed with the control pulse 310 being tailored to the specific physics of those hardware.

In other examples, the quantum system 312 may be an atomic, molecular or condensed matter system, in which a particular state is to be prepared in order to engineer chemical reactions, specific electronic or magnetic states, etc.

The disclosure of this document may also extend to a non-transient computer readable medium comprising instructions which cause a computer (such as computer 306 in FIG. 3) to enact the steps of any one of the methods discussed above.

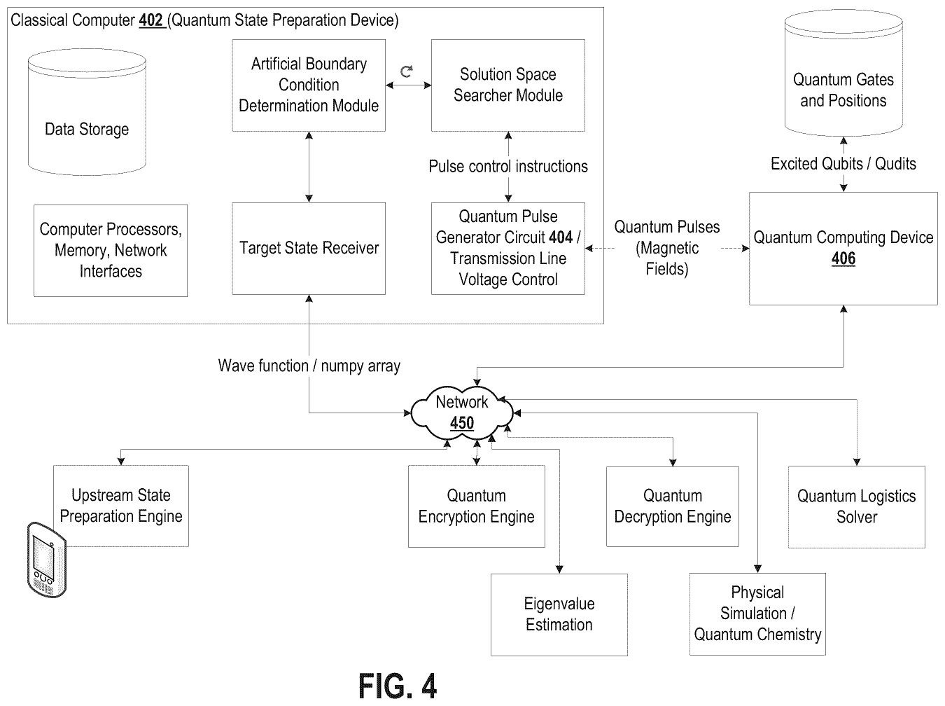

FIG. 4 is a more detailed example block schematic of the system of FIG. 3. In FIG. 4, the specific computing components carrying out the steps of the method 200 of FIG. 2 are shown. The classical computer 402 is coupled to the quantum pulse generator circuit 404 and the quantum computing device 406, architected to work together to provide a comprehensive and practically integrated technical solution to technical problems facing quantum state preparation, where the quantum computing advantage is eroded due to computational complexity. The quantum computing device 406 can be instantiated in an initial “zero energy” state or other initial state, and is not ready to be used for quantum processing yet, and must be driven to the target state.

The classical computer 402 can include data storage, computer processors, memory, and network interfaces which interoperate together. A target state receiver is configured to receive, across a network 450 or through an input interface, the target state as provided as a data object. As noted, the target state can be computationally represented as a data object such as a NumPy array representing a wavefunction of the target state, tp.

Upon receiving target state data object, the classical computer 402 can then computationally derive the artificial boundary condition using an Artificial Boundary Condition Determination Module, generating an intermediate data object representative of the determined artificial boundary conditions. As described herein in a variant embodiment, the artificial boundary condition can include the generation of multiple subsets that can be applied sequentially to reduce complexity if computing resources are limited (e.g. if the classical computer 402 is resource limited, such as on a portable computing device or on a mini PC due to space, portability, or thermal limitations).

The classical computer 402 receives or generates a data object representative of a time-dependent Schrödinger equation characterising the properties of the quantum computing system 406, wherein the Schrödinger equation has a potential term, V, wherein boundary conditions providing constraints on solutions are included in the Schrödinger equation. The control parameter r is provided which allows control of the form of the potential term V, and a momentum operator, ∇\hat{ }2, that are used to affect magnetic fields applied to the quantum computing system.

The time-dependent Schrödinger equation is an intermediate, derivative data object representing a time-domain optimisation problem in which the control parameter r is used as a controllable variable to minimise between a time-varying state of the quantum computing system, ψ(x,t,η), and the target state ψ̅ after a finite time T has elapsed, subject to limitations imposed by the Schrödinger equation, the boundary conditions, and an initial state of the quantum computing system.

The Solution Space Searcher Module of the classical computer 402 first transforms the derivative data object time-domain optimisation problem into the frequency domain data object to establish a semi-spectral variant of the time-domain optimisation problem by applying a Laplace or a Fourier transformation to the derivative data object. The Solution Space Searcher Module then utilizes the artificial boundary data object to constrain the searching, and computationally determines a form of η which drives the quantum computing system into the target state ψ̅ within time T.

When a solution is found, using the identified form of η, the Solution Space Searcher Module generates pulse control instructions to control a quantum pulse generator to form a pulse to vary the potential term V and the momentum operator ∇\hat{ }2; and drive the quantum computing system into the target state ψ̅ by imposing the pulse to the quantum computing system.

The Solution Space Searcher Module then provides the pulse control instructions to quantum pulse generator circuit 404 (or in a variant embodiment, to a transmission line voltage controller) which then drives the quantum computing device 406, through the establishment of quantum pulses in the form of specifically controlled magnetic fields that excite the qubits and qudits of the quantum gates and the specific quantum positions thereof.

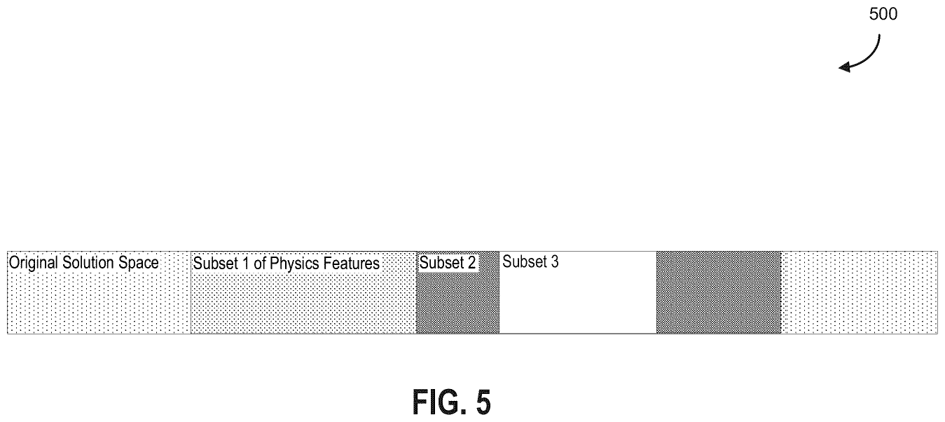

FIG. 5 is an illustration of an approach for establishing multiple artificial boundary conditions, according to an embodiment relating to multiple subsets to further reductions in computational complexity.

As a specific variation where there are further limitations on computational resources, the generation of the artificial boundary conditions can be conducted multiple times to generate multiple variations of the subsets with differing amounts of main features being factored into the model and differing amounts being discarded. In this variation shown at 500, a plurality of boundary conditions can be identified, each with different strictness levels in terms of features to be retained or discarded, and if an efficiently solvable optimisation cannot be found given the amount of computing resources, a next stricter approach is considered or implemented until a solution is found. In this variation, the approach can be tailored based on the amount of computing resources, which may not be known a priori, or in some cases, dynamically available depending on other computing tasks being performed by the computing system. From an implementation perspective, the Solution Space Searcher Module can be configured to sequentially use different subsets (broader, then narrower, and even narrower) if the classical computer 402 computational resources are under heavy strain or not able to find a convergent solution after a period of time has elapsed (because the search space is too large). This approach is useful to reduce the search space iteratively, providing a practical solution at the cost of accuracy.

### LIST OF CITATIONS USED IN THE TEXT

[1] Abdurrouf, M. A. Pamungkas, and M. Nurhuda, Numerical solution of the Schrödinger equation with periodic coulomb potential, Journal of Physics: Conference Series, 1825 (2021), p. 012105, doi:10.1088/1742-6596/1825/1/012105, https://dx.doi.org/10.1088/1742-6596/1825/1/012105.
[2]A. Aerts, P. Kockaert, S.-P. Gorza, A. Brown, J. Vander Auwera, and N. Vaeck, Laser control of a dark vibrational state of acetylene in the gas phase—fourier transform pulse shaping constraints and effects of decoherence, The Journal of Chemical Physics, 156 (2022).
[3]X. Antoine, A. Arnold, C. Besse, M. Ehrhardt, and a. schaedle, A review of transparent and artificial boundary conditions techniques for linear and nonlinear Schrödinger equations, Communications in Computational Physics, 4 (2008), pp. 729-796.
[4]G. G. Balint-Kurti, S. Zou, and A. Brown, Optimal control theory for manipulating molecular processes, Advances in chemical physics, 138 (2008), pp. 43-94.
[5]F. Bao, H. Deng, D. Ding, R. Gao, X. Gao, C. Huang, X. Jiang, H. sheng Ku, Z. Li, X. Ma, X. Ni, J. Qin, Z. Song, H. Sun, C. Tang, T. Wang, F. Wu, T. Xia, W. L. Yu, F. Zhang, G. Zhang, X. Zhang, J. Zhou, X. Zhu, Y. Shi, J. Chen, H.-H. Zhao, and C. Deng, Fluxonium: An alternative qubit platform for high-fidelity operations. Physical review letters, 129 1 (2021), p. 010502.
[6]J. Bardin, D. Sank, O. Naaman, and E. Jeffrey, Quantum computing: An introduction for microwave engineers, IEEE Microwave Magazine, 21 (2020), pp. 24-44, doi:10.1109/MMM.2020.2993475.
[7]V. Baskakov and A. Popov, Implementation of transparent boundaries for numerical solution of the Schrödinger equation, Wave Motion, 14 (1991), pp. 123-128, doi: https://doi.org/10.1016/0165-2125(91)90053-Q, https://www.sciencedirect.com/science/article/pii/016521259190053Q.
[8]A. D. Becke and R. M. Dickson, Numerical solution of Schrödinger's equation in polyatomic molecules, The Journal of Chemical Physics, 92 (1990), pp. 3610-3612, doi:10.1063/1.457869, https://doi.org/10.1063/1.457869,arXiv:https://pubs.aip.org/aip/jcp/article-pdf/92/6/3610/9732556/3610 1 online.pdf.
[9]K. Bergmann, H. Theuer, and B. Shore, Coherent population transfer among quantum states of atoms and molecules, Reviews of Modern Physics, 70 (1998), p. 1003.
[10]D. I. Bondar, K. Jacobs, G. Korpas, J. Marecek, et al., Quantum optimal control via polynomial optimization: A globally convergent approach, arXiv preprint arXiv:2209.05790, (2022).
[11]A. Borz'i, G. Ciaramella, and M. Sprengel, Formulation and numerical solution of quantum control problems, 2017. [12]R. A. Dalrymple and P. A. Martin, Perfect boundary conditions for parabolic water-wave models, Proceedings of the Royal Society of London. Series A: Mathematical and Physical Sciences, 437 (1992), pp. 41-54.
[13]D. d'Alessandro, Introduction to quantum control and dynamics, CRC press, 2021.
[14]M. Ehrhardt and C. Zheng, Exact artificial boundary conditions for problems with periodic structures, Journal of Computational Physics, 227 (2008), pp. 6877-6894, doi:10.1016/j.jcp.2008.03.042.
[15]W. R. Frensley, Boundary conditions for open quantum systems driven far from equilibrium, Rev. Mod. Phys., 62 (1990), pp. 745-791, doi:10.1103/RevModPhys.62.745, https://link.aps.org/doi/10.1103/RevModPhys.62.745.
[16]G. Friesecke, F. Henneke, and K. Kunisch, Frequency-sparse optimal quantum control, Mathematical Control and Related Fields, 8 (2018), pp. 155-176.
[17]C. E. Grosch and S. A. Orszag, Numerical Solution of Problems in Unbounded Regions: Coordinate Transforms, Journal of Computational Physics, 25 (1977), pp. 273-295, doi:10.1016/0021-9991(77)90102-4.
[18]J. R. Hellums and W. R. Frensley, Non-markovian open-system boundary conditions for the time-dependent Schrödinger equation, Phys. Rev. B, 49 (1994), pp. 2904-2906, doi:10.1103/PhysRevB.49.2904, https://link.aps.org/doi/10.1103/PhysRevB.49.2904.
[19]S. Herbert, No quantum speedup with grover-rudolph state preparation for quantum monte carlo integration, Physical Review E, 103 (2021), p. 063302.
[20]P. Intallura, G. Korpas, S. Chakraborty, V. Kungurtsev, and J. Marecek, A survey of quantum alternatives to randomized algorithms: Monte carlo integration and beyond, arXiv preprint arXiv:2303.04945, (2023).
[21]J. Koch, T. M. Yu, J. Gambetta, A. A. Houck, D. I. Schuster, J. Majer, A. Blais, M. H. Devoret, S. M. Girvin, and R. J. Schoelkopf, Charge-insensitive qubit design derived from the cooper pair box, Phys. Rev. A, 76 (2007), p. 042319, doi:10.1103/PhysRevA.76.042319, https://link.aps.org/doi/10.1103/PhysRevA.76.042319.
[22]F. Ladouceur, Boundaryless beam propagation, Opt. Lett., 21 (1996), pp. 4-5, doi:10.1364/OL.21.000004, https://opg.optica.org/ol/abstract.cfm?URI=ol-21-1-4.
[23]M. Levy, Perfectly matched layer truncation for parabolic wave equation models, Proceedings of The Royal Society A: Mathematical, Physical and Engineering Sciences, 457 (2001), doi:10.1098/rspa.2001.0848.
[24]V. Manucharyan, J. Koch, L. Glazman, and M. Devoret, Fluxonium: Single cooper-pair circuit free of charge offsets, Science (New York, N.Y.), 326 (2009), pp. 113-6, doi:10.1126/science.1175552.
[25]J. Papadakis, Exact, nonreflecting boundary conditions for parabolic-type approximations in underwater acoustics, Journal of Computational Acoustics, 02 (2011), doi:10.1142/S0218396X94000075.
[26]J. S. PAPADAKIS and E. T. FLOURI, A neumann to dirichlet map for the bottom boundary of a stratified sub-bottom region in parabolic approximation, Journal of Computational Acoustics, 16 (2008), pp. 409-425, doi:10.1142/S0218396X08003658, https://doi.org/10.1142/S0218396X08003658, arXiv:https://doi.org/10.1142/S0218396X08003658.
[27]T. Roth and S. Elkin, One-dimensional maxwell- Schrödinger hybrid simulation of transmon qubits, (2022), doi:10.48550/arXiv.2210.07923.
[28]T. E. Roth and S. T. Elkin, Maxwell- Schrödinger modeling of superconducting qubits coupled to transmission line networks, 2023, arXiv:2210.07923.
[29]T. E. Roth, R. Ma, and W. C. Chew, The transmon qubit for electromagnetics engineers: An introduction, IEEE Antennas and Propagation Magazine, 65 (2023), pp. 8-20, doi:10.1109/MAP.2022.3176593.
[30]M. Salehi and N. Granpayeh, Numerical solution of the Schrödinger equation in polar coordinates using the finite-difference time-domain method, J. Comput. Electron., 19 (2020),p. 91-102, doi:10.1007/s10825-020-01446-0, https://doi.org/10.1007/s10825-020-01446-0.
[31]I. L. SOFRONOV, Artificial boundary conditions of absolute transparency for two- and three-dimensional external time-dependent scattering problems, European Journal of Applied Mathematics, 9 (1998), p. 561-588, doi:10.1017/S0956792598003507.
[32]N. V. Vitanov, T. Halfmann, B. W. Shore, and K. Bergmann, Laser-induced population transfer by adiabatic passage techniques, Annual review of physical chemistry, 52 (2001), pp. 763-809.
[33]G. Yao, N. V. da Silva, and D. Wu, An effective absorbing layer for the boundary condition in acoustic seismic wave simulation, Journal of Geophysics and Engineering, 15 (2018), pp. 495-511, doi:10.1088/1742-2140/aaa4da, https://doi.org/10.1088/1742-2140/aaa4da, arXiv:https://academic.oup.com/jge/article-pdf/15/2/495/25533352/jge 15 2 495.pdf.
[34]R. N. Zare, Laser control of chemical reactions, science, 279 (1998), pp. 1875-1879.
[35]C. Zheng, An exact absorbing boundary condition for the Schrödinger equation with sinusoidal potentials at infinity, Communications in Computational Physics, 3 (2008).
[36]A. Abbas, A. Ambainis, B. Augustino, A. Bärtschi, H. Buhrman, C. Coffrin, G. Cortiana, V. Dunjko, D. J. Egger, B. G. Elmegreen, et al., Quantum optimization: Potential, challenges, and the path forward, arXiv preprint arXiv:2312.02279, (2023).
[37]T. Caneva, T. Calarco, and S. Montangero, Chopped random-basis quantum optimization, Physical Review A, 84 (2011), doi:10.1103/physreva.84.022326, http://dx.doi.org/10.1103/366 PhysRevA.84.022326.367
[38]L. Grover and T. Rudolph, Creating superpositions that correspond to efficiently integrable probability distributions, arXiv preprint quant-ph/0208112, (2002).
[39]L. K. Grover, Synthesis of quantum superpositions by quantum computation, Physical Review Letters, 85 (2000), p. 1334-1337, doi:10.1103/physrevlett.85.1334, http://dx.doi.org/10.1103/PhysRevLett.85.1334.387
[40]S. Kak, The initialization problem in quantum computing, Foundations of Physics, 29 (1999), pp. 267-279.
[41]N. Khaneja, T. Reiss, C. Kehlet, T. Schulte-Herbr-Uggen, and S. J. Glaser, Optimal control of coupled spin dynamics: design of nmr pulse sequences by gradient ascent algorithms, Journal of Magnetic Resonance, 172 (2005), p. 296-305, doi:10.1016/j.jmr.2004.11.004,http://dx.doi.org/10.1016/j.jmr.2004.11.004.
[42]C. P. Koch, U. Boscain, T. Calarco, G. Dirr, S. Filipp, S. J. Glaser, R. Kosloff, S. Montangero, T. Schulte-Herbrüggen, D. Sugny, and F. K. Wilhelm, Quantum optimal control in quantum technologies. strategic report on current status, visions and goals for research in europe, EPJ Quantum Technol-ogy, 9 (2022), doi:10.1140/epjqt/s40507-022-00138-x, http://dx.doi.org/10.1140/epjqt/s40507-022-00138-x.
[43]M. Plesch and “C. Brukner, Quantum-state preparation with universal gate decompositions, Physical Review A, 83 (2011), p. 032302.
[44]E. Y. Zhu, S. Johri, D. Bacon, M. Esencan, J. Kim, M. Muir, N. Murgai, J. Nguyen, N. Pisenti, A. Schouela, K. Sosnova, and K. Wright, Generative quantum learning of joint probability distribution functions, Phys. Rev. Res., 4 (2022), p. 043092, doi:10.1103/PhysRevResearch.4.043092, https://link.aps.org/doi/10.1103/PhysRevResearch.4.043092.
[45]C. Zoufal, A. Lucchi, and S. Woerner, Quantum generative adversarial networks for learning and loading random distributions, npj Quantum Information, 5 (2019), doi:10.1038/s41534-019-0223-2, http://dx.doi.org/10.1038/s41534-019-0223-2.

1. A system adapted for encoding a target state on a quantum computing system by driving the quantum computing system into the target state using a frequency-domain based harmonic-analytic approach, the system comprising:
a classical computer including at least one processor coupled to computer memory and non-transitory data storage, the at least one processor configured to:
receive a data object representative of a time-dependent Schrödinger equation characterising the properties of the quantum computing system, wherein the Schrödinger equation has a potential term, V, wherein boundary conditions providing constraints on solutions are included in the Schrödinger equation, and wherein a control parameter η is provided which allows control of the form of the potential term V, and a momentum operator, ∇², that are used to affect magnetic fields applied to the quantum computing system;
receive a data object representative of a description of the target state, ψ̅, to be encoded on the quantum computing system;
generate a derivative data object representing a time-domain optimisation problem in which the control parameter η is used as a controllable variable to minimise between a time-varying state of the quantum computing system, ψ(x, t, η), and the target state ψ̅ after a finite time T has elapsed, subject to limitations imposed by the Schrödinger equation, the boundary conditions, and an initial state of the quantum computing system;
transform the derivative data object time-domain optimisation problem into the frequency domain data object to establish a semi-spectral variant of the time-domain optimisation problem by applying a Laplace or a Fourier transformation to the derivative data object;
determine a form of η which drives the quantum computing system into the target state ψ̅ within time T;
using the identified form of η, control a quantum pulse generator to form a pulse to vary the potential term V and the momentum operator ∇²; and
drive the quantum computing system into the target state ψ̅ by imposing the pulse to the quantum computing system.

2. The system of claim 1, wherein the data object representative of the time-dependent Schrödinger equation includes one or more artificial boundary conditions, the one or more artificial boundary conditions are imposed on the potential term V, the one or more artificial boundary conditions artificially limiting a search space in a spatial domain, yielding a computational advantage given finite computing resources of the classical computer.

3. The system of claim 2, wherein the one or more artificial boundary conditions are selected using both a shape of a domain and one or more system features.

4. The system of claim 3, wherein a spatial location of the boundary conditions is selected to include a spatial region which captures a selected subset of feature characteristics of the quantum computing system.

5. The system of claim 1, wherein the potential term, V, is provided in a piecewise manner such that the potential term, V, has a first form in a first region outside the spatial locations of the boundary conditions and a second form in a second region inside the spatial locations of the boundary conditions.

6. The system of claim 5, wherein the potential term, V, is set at a constant value in the first region and the control parameter, η, is used to alter the form of the potential term in the second region.

7. The system of claim 1, wherein the potential term, V, is a periodic potential.

8. The system of claim 1, wherein the frequency-domain optimisation problem includes a regularisation function.

9. The system of claim 1, wherein the target state for the quantum computing system is provided by stating the state and the basis in which that state is expressed and calculating the target state.

10. The system of claim 1, further comprising the quantum pulse generator, the quantum pulse generator configured to both form the pulse and impose the pulse onto gate components of the quantum computing system.

11. A method for encoding a target state on a quantum computing system by driving the quantum computing system into the target state using a frequency-domain based harmonic-analytic approach, the method comprising:
receiving, by a classical computer, a data object representative of a time-dependent Schrödinger equation characterising the properties of the quantum computing system, wherein the Schrödinger equation has a potential term, V, wherein boundary conditions providing constraints on solutions are included in the Schrödinger equation, and wherein a control parameter η is provided which allows control of the form of the potential term V, and a momentum operator, ∇², that are used to affect magnetic fields applied to the quantum computing system;
receiving, by the classical computer, a data object representative of a description of the target state, ψ̅, to be encoded on the quantum computing system;
generating, by the classical computer, a derivative data object representing a time-domain optimisation problem in which the control parameter η is used as a controllable variable to minimise between a time-varying state of the quantum computing system, ψ(x, t, η), and the target state ψ̅ after a finite time T has elapsed, subject to limitations imposed by the Schrödinger equation, the boundary conditions, and an initial state of the quantum computing system;
transforming, by the classical computer, the derivative data object time-domain optimisation problem into the frequency domain data object to establish a semi-spectral variant of the time-domain optimisation problem by applying a Laplace or a Fourier transformation to the derivative data object;
determining, by the classical computer, a form of η which drives the quantum computing system into the target state ψ̅ within time T;
using the identified form of η, forming, by a quantum pulse generator coupled to the classical computer, a pulse to vary the potential term V and the momentum operator ∇²; and
driving, by the quantum pulse generator, the quantum computing system into the target state ψ̅ by imposing the pulse to the quantum computing system.

12. The method of claim 11, wherein the data object representative of the time-dependent Schrödinger equation includes one or more artificial boundary conditions, the one or more artificial boundary conditions are imposed on the potential term V, the one or more artificial boundary conditions artificially limiting a search space in a spatial domain, yielding a computational advantage given finite computing resources of the classical computer.

13. The method of claim 12, wherein the one or more artificial boundary conditions are selected using both a shape of a domain and one or more system features.

14. The method of claim 13, wherein a spatial location of the boundary conditions is selected to include a spatial region which captures a selected subset of feature characteristics of the quantum computing system.

15. The method of claim 11, wherein the potential term, V, is provided in a piecewise manner such that the potential term, V, has a first form in a first region outside the spatial locations of the boundary conditions and a second form in a second region inside the spatial locations of the boundary conditions.

16. The method of claim 15, wherein the potential term, V, is set at a constant value in the first region and the control parameter, η, is used to alter the form of the potential term in the second region.

17. The method of claim 11, wherein the potential term, V, is a periodic potential.

18. The method of claim 11, wherein the frequency-domain optimisation problem includes a regularisation function.

19. The method of claim 11, wherein the target state for the quantum computing system is provided by stating the state and the basis in which that state is expressed and calculating the target state.

20. A non-transitory computer readable medium comprising machine interpretable instructions which when executed by a processor, cause the processor to execute a method
for encoding a target state on a quantum computing system by driving the quantum computing system into the target state using a frequency-domain based harmonic-analytic approach, the method comprising:
receiving, by a classical computer, a data object representative of a time-dependent Schrödinger equation characterising the properties of the quantum computing system, wherein the Schrödinger equation has a potential term, V, wherein boundary conditions providing constraints on solutions are included in the Schrödinger equation, and wherein a control parameter η is provided which allows control of the form of the potential term V, and a momentum operator, ∇², that are used to affect magnetic fields applied to the quantum computing system;
receiving, by the classical computer, a data object representative of a description of the target state, ψ̅, to be encoded on the quantum computing system;
generating, by the classical computer, a derivative data object representing a time-domain optimisation problem in which the control parameter η is used as a controllable variable to minimise between a time-varying state of the quantum computing system, ψ(x, t, η), and the target state after a finite time T has elapsed, subject to limitations imposed by the Schrödinger equation, the boundary conditions, and an initial state of the quantum computing system;
transforming, by the classical computer, the derivative data object time-domain optimisation problem into the frequency domain data object to establish a semi-spectral variant of the time-domain optimisation problem by applying a Laplace or a Fourier transformation to the derivative data object;
determining, by the classical computer, a form of η which drives the quantum computing system into the target state ψ̅ within time T;
using the identified form of η, forming, by a quantum pulse generator coupled to the classical computer, a pulse to vary the potential term V and the momentum operator ∇²; and
driving, by the quantum pulse generator, the quantum computing system into the target state ψ̅ by imposing the pulse to the quantum computing system.
